(19) United States
(12) Patent Application Publication
(10) Pub. No.: US 2015/0190814 A1
(43) Pub. Date: Jul. 9, 2015

(54) FOLDABLE PLACER MINING BACKPACK

(71) Applicant: Randy Melvin Barass, Yellowhead County (CA)

(72) Inventor: Randy Melvin Barass, Yellowhead County (CA)

(21) Appl. No.: 14/149,776

(22) Filed: Jan. 7, 2014

(51) Int. Cl. B03B 7/00; A45F 3/08; A45F 4/02; B03B 5/26

(52) U.S. Cl. CPC B03B 7/00; B03B 5/26; A45F 3/08; A45F 4/02

(57) ABSTRACT

A conveniently portable placer mining apparatus structured to be folded and worn as a backpack, the hopper functioning as the storage compartment of the backpack, wherein prospecting equipment may be secured or placed. The apparatus may comprise at least two stages and in some embodiments a supporting stand, which when the apparatus is folded is configured for shoulder straps to be attached thereto so that the stand is essentially the backpack frame, carried on a person's back and/or shoulders. The stages and the supporting stand(s) (in embodiments where incorporated) may unfold easily for quick set up and take down. In embodiments comprising at least three stages, the second stage and third stages may both comprise different portions of a sluice box, each with different angles of inclination and other features for capturing a range of sizes of desirable mineral particles. In one embodiment, the apparatus is a three-stage high banker.

### BACKGROUND

Prospecting tools/methods usually have the dual and sometimes conflicting objectives of convenient portability and effectively capturing desirable mineral particles. Effectiveness may be measured, among other criteria, by the time required to yield certain positive results. Better results may be achieved in less time when a miner can arrive more quickly to a prospecting location, spend less time setting up and cleaning up prospecting equipment, and when the location is more laden with desirable mineral particles. However, since placer mining has existed for centuries and the desirable mineral particles in many more easily accessible locations have already been discovered and gathered, many recreational placer miners today are motivated to access remote locations to find hitherto undiscovered desirable mineral particles.

Transporting all of a miner's prospecting equipment in one trip to a remote location is not always easy, regardless of whether a miner utilizes a traditional sluice box or a high banker, which are just two common pieces of placer mining equipment. A typical sluice box funnels water and mineral deposit through a sluice into a box, forming an artificial channel. Since more desirable mineral particles are often heavier and therefore fall more quickly to the sluice box floor, riffles and matting are usually located along the sluice box floor to trap such desirable mineral particles. To increase effectiveness, some sluice boxes incorporate additional or lenghtened areas of matting and/or riffles, often called stages, which the slurry must pass through before exiting the sluice box.

Most sluice boxes are limited to use in or contiguous to water sources, which can present certain disadvantages. For example, using a sluice box to prospect mineral deposit any distance away from a stream can be laborious, time-consuming, and even impractical. Moreover, depositing the slurry back into the water source can cause harm to the environment by, for example, disrupting a potentially fish-bearing ecosystem. Consequently, miners often prefer to utilize high bankers for prospecting. High bankers incorporate spray bars, hoses or pipes, and pumps or motors to transport water from a water source to a sluice box located a certain distance away from the water source, thus sparing a miner from having to carry each load back to the water source, and also allowing the slurry to exit a high banker on dry land, safely away from the water source. Nevertheless, due to the additional parts and weight of all the equipment required to prospect using a high banker, high bankers (especially average-sized, multi-stage high bankers) are less easily portable than typical sluice boxes. Due to all of their additional parts, high bankers also generally take longer to set up and clean up than sluice boxes.

Some placer mining apparatuses attempt to avoid dependence on external water sources altogether by using alternative methods of separating the desirable mineral particles from the undesirable, yet these usually share some of the portability disadvantages inherent to prior art sluice boxes and high bankers generally. That is, it is often difficult for one miner by him or herself to simultaneously transport an average-sized placer mining apparatus, and all other necessary prospecting equipment, in one trip, to a potentially remote prospecting location.

It would be beneficial if a lightweight, multi-stage placer mining apparatus existed that was effective at prospecting yet could be carried, along with all necessary prospecting equipment, easily and comfortably by one miner. It would also be desirable if such a placer mining apparatus could be set up, cleaned up, and taken down relatively easily and quickly, and if (in its high banker embodiment) it conserved energy and water.

### SUMMARY OF THE INVENTION

A placer mining apparatus structured to be folded in or as a backpack so that, when in its folded position the hopper functions as the compartment of the backpack, wherein prospecting equipment may be secured or placed. The hopper may, in one embodiment, be of sufficient size to allow an average-sized shovel to easily place material therein. As described in greater detail below, when the apparatus is in its folded position, one portion or side may serve as the frame of the backpack to which shoulder straps may be attached, and which may be placed against a miner's back or shoulders, in such a manner that the movement of the person carrying the apparatus-backpack is not limited (e.g., the apparatus does not interfere with motion the miner's legs, the width of the high banker backpack does not protrude substantially beyond the lateral body width of the miner, etc.). In addition, the apparatus may be set up/unfolded surprisingly quickly and easily, without many separate parts having to be assembled prior to operation. Once a prospecting session is completed, desirable mineral particles captured by the apparatus may be gathered, and cleaning and folding may take place in a relatively quick and easy manner.

Each stage incorporated by the apparatus may present certain advantages relating to effectiveness, portability, and quicker set up and clean up. The first stage, for example, may be comprised of a classifier (over a grizzly screen) and a hopper. In one embodiment, the size of the hopper may accommodate a normal sized-shovel. The hopper may be open ended on one side to allow exiting of larger stones. The hopper in one embodiment may be box-shaped, and opposite from the open ended sided of the hopper may be a closed side, which when the apparatus is in its folded position as a backpack, may serve as the floor of the backpack compartment, upon which prospecting equipment may rest or above which prospecting equipment may be secured. In one embodiment, the dimensions of the hopper when serving as the backpack compartment may be sufficient to accommodate a five gallon plastic pail, which pail may be fastened more securely by means of straps.

When unfolded and in a ready-for-prospecting position, the first stage may be supported one or more supporting stands. For example, one smaller hopper supporting stand may adjust the angle of inclination of the first stage by propping up the back end (or receiving end) of the hopper. A steeper angle of inclination may allow gravity to assist in carrying the mineral deposit in a downward direction towards the open side (or discharge end). The discharge end of the hopper may be held in an elevated position (above the next stage(s)) by a large supporting stand, which may be attached to the front or discharge end of the hopper. In one embodiment, this large supporting stand, when the apparatus is in a folded position, may be the upper portion of the frame of the backpack. In one embodiment, the side of the large supporting stand that is placed on a ground surface when the apparatus is in an unfolded position, may be wider than the top side, which top side may be connected with the discharge end of the hopper. Said shape may not only provide greater stability, but may also be configured to distribute weight over a certain surface area of a miner's back and shoulders. In addition, when the apparatus is in its folded position, said large supporting stand/backpack frame may be located against or opposite the underside of the hopper surface (above which the classifier is placed), where a substantial portion of the weight of the high banker backpack and prospecting equipment may be located. Shoulder straps may attach to the apparatus in its folded position and in one embodiment said straps may attach to the large supporting stand/backpack frame. The hopper and supporting stands and other components of certain embodiments of the apparatus may be comprised of lightweight yet durable material, such as in one embodiment light gauge aluminum.

The classifier may allow sufficiently small mineral particles to pass therethrough. In one embodiment, this may be accomplished by an aluminum punch plate perforated with holes. The classifier may also be easily removable to facilitate cleaning (and for dislodging small stones that may become lodged within the holes)—in one embodiment, by simply loosening two small bolts and wing nuts.

Smaller particles of mineral deposit may pass through the classifier to the second stage, while larger particles may slide off the open side/discharge end of the hopper. In an embodiment where the placer mining apparatus is a high banker, the discharged material may fall onto a ground surface. Due to the shape and position of the large supporting stand, in one embodiment (incorporating such a stand), these larger rejected particles may slide down and around the large supporting stand in a somewhat controlled manner, and may be positioned with the aid of a shovel to provide additional stability to the large supporting stand. In such a high banker embodiment, the first stage may also comprise a spray bar, which may be comprised of lightweight yet durable material such as, in one embodiment, polyvinyl chloride (PVC) piping.

The size of the first stage parts of the high banker embodiment may also lend to convenient portability and water/energy conservation without substantially sacrificing effectiveness. Specifically, the parts may be designed to accommodate less water flow than prior art high bankers having similarly-sized hoppers. For example, in one embodiment, the spray bar may be comprised of ¾″ PVC piping rather than 1″ piping, thereby requiring less water volume to pass through the spray bar without substantially diminishing water pressure. In addition, with less water volume required, the smaller PVC pipe may allow pumping by a potentially lighter and less energy-consuming pump, such as in one embodiment a one-inch outlet pump

The second stage of the apparatus may comprise all or a portion of a sluice box, and may fold compactly on top of the support stand, which then may both fold under the backside of the first stage so that the apparatus may be carried as a backpack in the manner described above. In an embodiment of the apparatus comprising at least three stages, the second and third stages may both comprise portions of a sluice box and each stage may incorporate distinct designs for trapping different ranges of sizes of desirable mineral particles. The second stage, in one three-stage embodiment, may incorporate certain features intended to capture larger, heavier, and/or coarser desirable mineral particles. One such feature is a second stage angle of inclination that is steeper than that found in the prior art. For example, in some embodiments, the angle of inclination of the second stage with respect to a ground surface may be between 15 and 25 degrees (and in one embodiment may be about 20 degrees) from the horizontal axis of a ground surface. A steeper angle of inclination may also result in less trapping of undesirable mineral particles in proportion to desirable particles.

This steeper angle of inclination may be achieved, in one embodiment, by the second stage portion of the sluice box being attached on one end to the large supporting stand and being attached on the other end to a smaller back supporting stand. In one embodiment of the apparatus, the smaller supporting stand supporting the receiving end of the hopper may be connected to the second stage portion of the sluice box in a manner to provide stability, and/or in another embodiment, to minimize the size required of the small supporting stand. In one embodiment, the angles of inclination of the first, second, and any additional stages may vary by adjusting the positions of the stages with respect to the supporting stands.

In an at least three-stage embodiment, the second stage may also incorporate riffles designed to trap larger, heavier, and/or coarser desirable mineral particles. For example, in one embodiment the riffles may be shorter in height and more horizontally curved against direction of the water flow than prior art riffles, which, possibly in combination with the steeper angle of inclination, may present certain advantages. In some embodiments, the height of the riffles may range from about 0.3-0.6 inches. The riffles may also be, in one embodiment, fixed in place, thus decreasing the steps required for assembling/disassembling the high banker. Such non-removable riffles may also provide strengthening support to the structure of the second stage portion of the sluice box, without the sluice box having to be comprised of heavier material. Desirable mineral particles captured in the second stage riffles may be gathered using either a snuffer bottle or simply by using water to rinse out the particles into a container.

The width of the second stage portion of the sluice box may be substantially narrower than the width of the hopper. This narrower width may make the second stage lighter than a wider second stage sluice box. In addition, the narrower second stage width may also allow a more consistent water and slurry flow over the riffles when there is less water flow volume generated. The second stage portion of the sluice box may also be quite long, thus increasing the opportunity for trapping desirable mineral particles. In one embodiment, the length of the second stage of the sluice box may be about 36 inches.

In a high banker embodiment, the narrower width and the steeper angle of inclination of the second stage may be an energy-efficient means of increasing the velocity and consistency of slurry flow without requiring a stronger pump to generate additional force.

Rather than repeat the same basic features and dimensions of a prior stage such as the second stage, embodiments of the apparatus comprising at least three stages may comprise stages incorporating distinct features designed for trapping different sizes of desirable mineral particles. For example, as opposed to a second stage designed to trap larger, heavier, and/or coarser desirable mineral particles, a third stage may be designed to capture smaller, lighter, and/or finer desirable mineral particles. Such third stage features may accomplish this objective by, in one embodiment, causing the flow of the water and slurry to slow down, for example, by having a substantially less steep angle of inclination than the second stage, and by the third stage portion of the sluice box being wider than the second stage. The angle of inclination, in some embodiments, may vary between 5 and 15 degrees (and in one particular embodiment, 10 degrees) from the horizontal axis of a ground surface. In one embodiment, the angle of inclination of the third stage may be created by a small back supporting stand, which may support one end of the third stage, with the other side resting substantially on the plane of the ground surface. In one embodiment, the width of the third stage portion of the sluice box may be wider than the second stage width—about seven inches (as opposed to one embodiment's second stage portion of the sluice box having a six-inch width) in one particular embodiment. The third stage may have a relatively long length, providing more opportunity for the targeted desirable mineral particles to be trapped therein. In one embodiment, the length of the third stage may be roughly thirty inches.

The third stage may also, in one embodiment, incorporate riffles designed to trap smaller desirable mineral particles or, in another embodiment, an expanded sheet of metal containing a series of elongated hexagonal-shaped perforations. Under the riffles or metal sheet may be matting for trapping the smaller, finer, and/or lighter desirable mineral particles. In one embodiment, said matting may not have a backing, which may allow for easier removal of the desirable mineral particles trapped therein by rinsing of the matting. To facilitate cleaning and gathering of desirable mineral particles, in one embodiment, an additional stage portion of the sluice box (such as the third stage) may be easily detachable from the prior or second stage portion of the sluice box. The additional stage portions of a sluice box (for embodiments incorporating such additional stages) may also be comprised of lightweight material, such as in one embodiment, light gauge aluminum.

The (at least) three stages and supporting stands (for the applicable embodiments incorporating such additional stages and stands) may also fold easily and compactly, allowing for quicker set up and, once a prospecting session is completed, for quicker clean up and disassembly. As previously mentioned, when folded the apparatus may be a backpack with the hopper in such a position that it may be a storage compartment, with the weight of the apparatus and any equipment/objects carried therein centered and distributed across a miner's back and shoulders, in one embodiment, through the shoulder straps and a portion of the apparatus serving as a backpack frame, which portion in one embodiment may be the large supporting stand.

When the apparatus is in its folded position and carried on a miner's back and shoulders, one side of the hopper may serve as the floor of the backpack compartment, upon or above which floor may be placed or secured objects, such as a pail or bucket, inside which smaller items (such as a snuffer bottle) may be placed. In the high banker embodiment, such objects may also include water delivery hoses, etc. In one embodiment where the hopper has a substantially-box shape, with an open end for rejecting/discharging larger stones, the wall of the hopper opposite from the open end of the hopper (i.e., the receiving end of the hopper) may be essentially, when the apparatus is in its folded position, the floor of the external storage compartment. Folding and utilizing the high banker as a backpack in this manner may leave the prospector's hands free to carry other prospecting items, such as for example a water pump and a standard-sized shovel (which in one embodiment may be a number 2 sized shovel). In addition to unfolding from its folded position in several surprisingly easy and quick steps (as described in more detail below for specific embodiments), in certain embodiments of the apparatus incorporating supporting stands, time is saved by not having to separately attach legs to a placer mining apparatus (where such legs would otherwise be required). Once a prospecting session is complete, the apparatus may allow gathering of captured desirable mineral particles, cleaning up, and re-folding so that it may be carried as a backpack, all in a relatively expeditious and convenient manner.

The above description and listed alternative embodiments are considered that of some embodiments only. It is understood that the embodiments shown in the drawings and described below are merely for illustrative purposes and not intended to limit scope. Alterations and modifications, therefore, and such further applications as would occur to those skilled in the relevant art(s), are also contemplated. For example, the shape of the hopper may vary, and the shape of various other components such as the supporting stands may also vary.

### BRIEF DESCRIPTION OF THE DRAWINGS

FIG. 1 is a perspective view of a placer mining apparatus that is a three-stage high banker.

FIG. 2 is a perspective view of the apparatus of FIG. 1, along with other prospecting equipment, being carried by a miner.

FIGS. 3A-3D illustrate the steps of unfolding the apparatus of FIGS. 1 and 2 from a folded position to an unfolded position.

FIG. 4 is a front view of the first stage hopper of the apparatus of FIG. 1.

FIG. 5 is a rear view of the apparatus of FIG. 1, showing second stage and third stage portions of a sluice box.

FIG. 5A is a close-up side view of a riffle of the second stage portion of the sluice box of FIG. 5.

FIG. 5B is a close-up top perspective view of the point where the second stage and third stage portions of the sluice box of FIG. 5 may attach and detach.

FIG. 5C is a top view of the third stage portion of the sluice box of FIG. 5.

FIG. 6 is a side view of the apparatus of FIG. 1.

FIG. 7 illustrates a miner using the apparatus of FIG. 1.

### DETAILED DESCRIPTION OF THE DRAWINGS

“Desirable mineral particles” are defined herein as those mineral particles for which a miner is searching, such as for example (but not limited to) gold, platinum, silver, etc. “Undesirable mineral particles” are those mineral particles that are not desirable mineral particles. “High banker” is defined herein as a placer mining apparatus comprising a sluice box, but not limited to use in or contiguous to a water source. “Compartment” is defined as a space within which an object may rest or be placed or be secured, and does not necessarily constitute an enclosed space. “Within” is defined as substantially inside, so that an object is considered within a compartment even where not the entire object is inside an enclosed or substantially enclosed space. “Surrounding” is defined as substantially around, or more around than not around, but not necessarily all around. The numerical values described herein are mostly approximations and are not intended to be interpreted strictly or inflexibly.

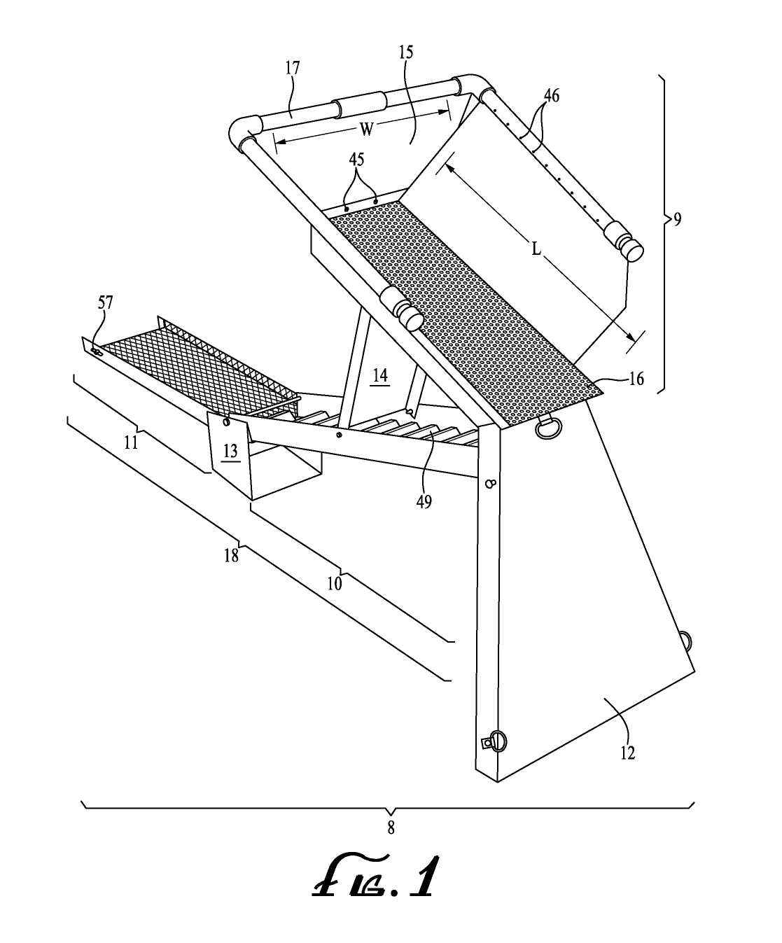

Turning to the drawings, FIG. 1 is a perspective view of a placer mining apparatus that is a high banker 8 comprising a first stage 9, a second stage 10, and a third stage 11, as well as larger supporting stand/backpack frame 12, a smaller or back supporting stand 13, and a hopper supporting stand 14. The first stage may be comprised of a hopper/backpack compartment 15, a classifier 16, and a spray bar 17. The various components of the three stages of the high banker 9, 10, 11 and the supporting stands 12, 13, 14 may be lightweight. For example, relating to the first stage 9, in one embodiment the hopper 15 may be made of lightweight aluminum, and the spray bar 17 may be comprised of smaller-width PVC pipe, which in one embodiment may be ¾″, durable schedule 40 ultra-violet resistant piping (and compatible with use of a standard-sized garden hose).

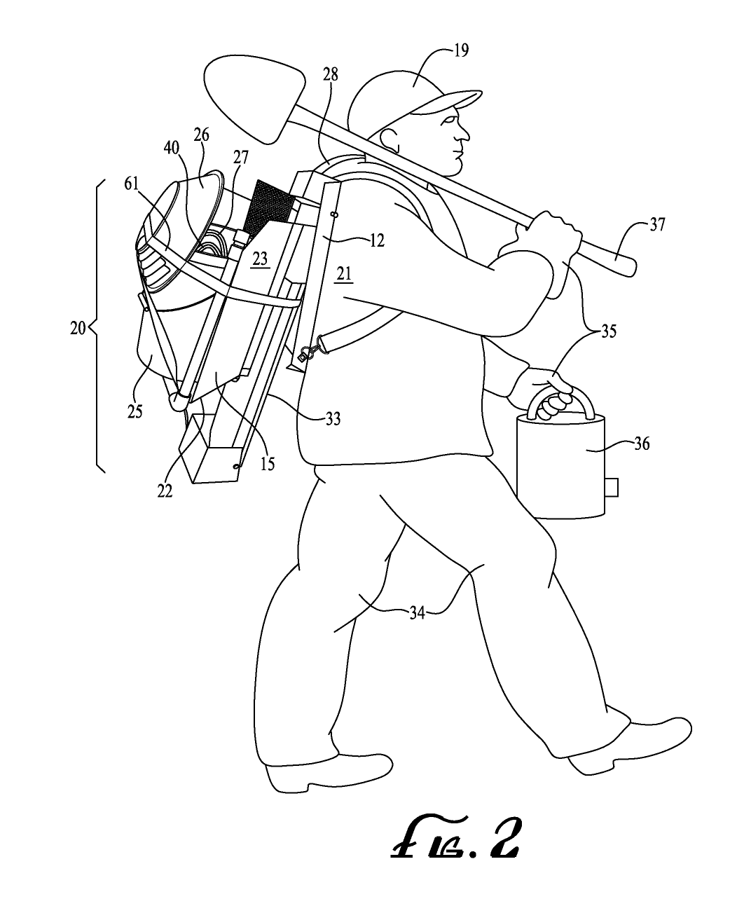

As shown in FIGS. 1, 3A and 4, the hopper 15 of the first stage 9 has a longitudinal length L and a lateral width W. The lateral width W and longitudinal length L are configured to be of sufficient length and width to handle several shovel 37 full loads of mineral deposit 44 yet be of a proper size to function as the outer storage compartment 15 of the backpack 20 for carrying objects placed or secured therein, when the other stages 9, 10, 11, and supporting stands 12, 13, 14, are folded so that the apparatus 8 may be carried as a backpack 20 by the miner 19, without interfering with movement of the miner's legs 34 (as shown in FIG. 2). For example, the length L of the hopper 15 may vary widely and in some embodiments may be in the range of 15 inches to 30 inches long, and in the embodiment described herein (in this section) may be 20 inches. The lateral width W is configured to be of sufficient width to accommodate the width of a standard size shovel 37 depositing a load of mineral deposit 44 therein yet narrow enough that it can be carried by the miner 19 when folded as a backpack 20 without extending substantially beyond the width of the miner's 19 back and shoulders 21. For example, the width W of the hopper 15 may vary widely and in some embodiments may be in the range of 16 inches to 20 inches wide, and in the embodiment described herein may be about 18.5 inches.

The second stage 10 and the third stage 11 may both comprise separate portions of a sluice box 18, and may also be comprised of lightweight material such as, in one embodiment, lightweight aluminum. The second stage 10 and the third stage 11 portions of the sluice box 18 may both be relatively narrow in comparison to the width of the hopper 15 (although the third stage 11 in one embodiment, as explained below, may not be as narrow as the second stage 10). The larger supporting stand 12, the smaller supporting stand 13, and the hopper support stand 14, may also be made of lightweight material, such as in one embodiment light gauge aluminum. In one embodiment, the total weight of the three-stage portable high banker 8 may be under or around twenty pounds.

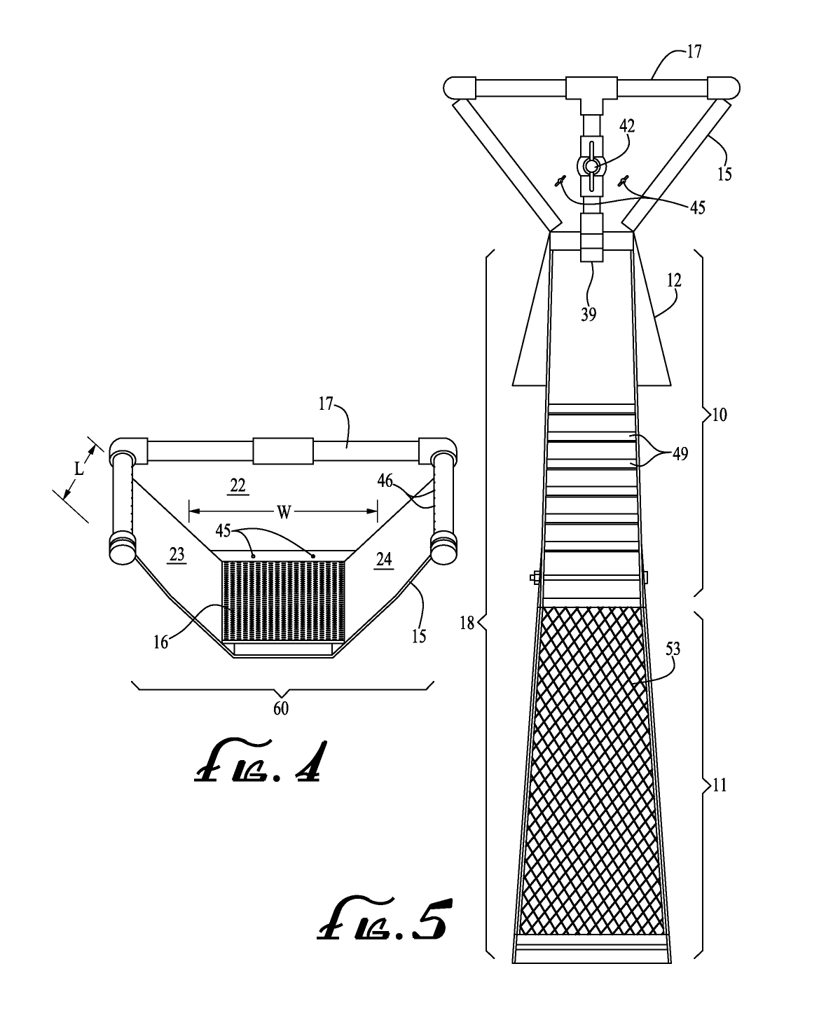

As explained in more detail below, the stages 9, 10, 11 and the supporting stands 12, 13, 14 of the high banker 8 may fold in a compact position for more convenient storage and portability, and as shown in FIG. 2 may become a backpack 20 that a miner 19 may carry on his/her back and shoulders 21 with the assistance of shoulder straps 28. In its folded position as a backpack 20, the hopper 15 may serve as the backpack's external storage compartment 15. More specifically, in the embodiment shown in FIGS. 2 and 4, the hopper 15 may basically form a box, with one side of the box being open ended 60. Adjacent to the open ended side 60 may be two sidewalls 23, 24 that, along with the classifier 16 surface, may serve as three sidewalls 23, 24 of the hopper backpack compartment 15 (when the backpack 20 is in its folded position). Opposite from the open ended side 21 may be a closed side 22 that, when the high banker backpack 20 is in its folded position, may serve as the bottom surface or floor 22 of the hopper backpack compartment 15, upon or above which prospecting equipment such a bucket 25, a pan 26, and first and second hoses 27, 40 may be placed and/or secured with the aid of straps 61. Smaller items/equipment may also be placed inside the bucket 25. When the high banker backpack 20 is in its folded position, the dimensions of the hopper backpack compartment 15 may be of sufficient size to accommodate a standard five-gallon plastic pail/bucket 25 used in placer work.

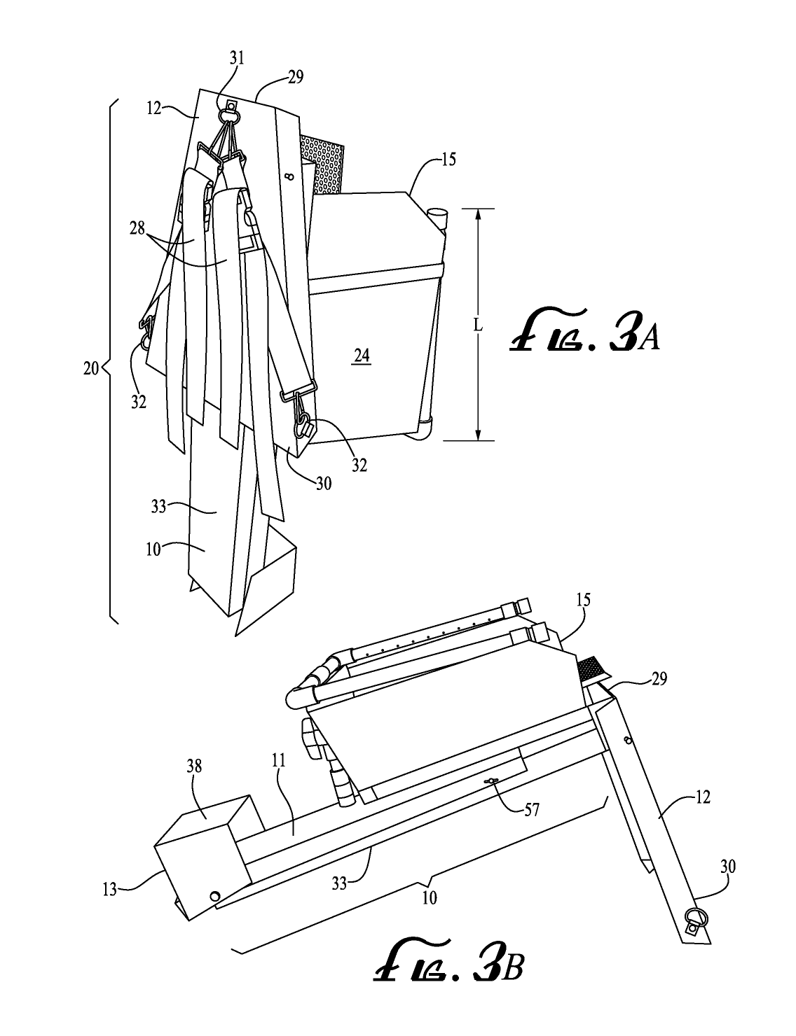

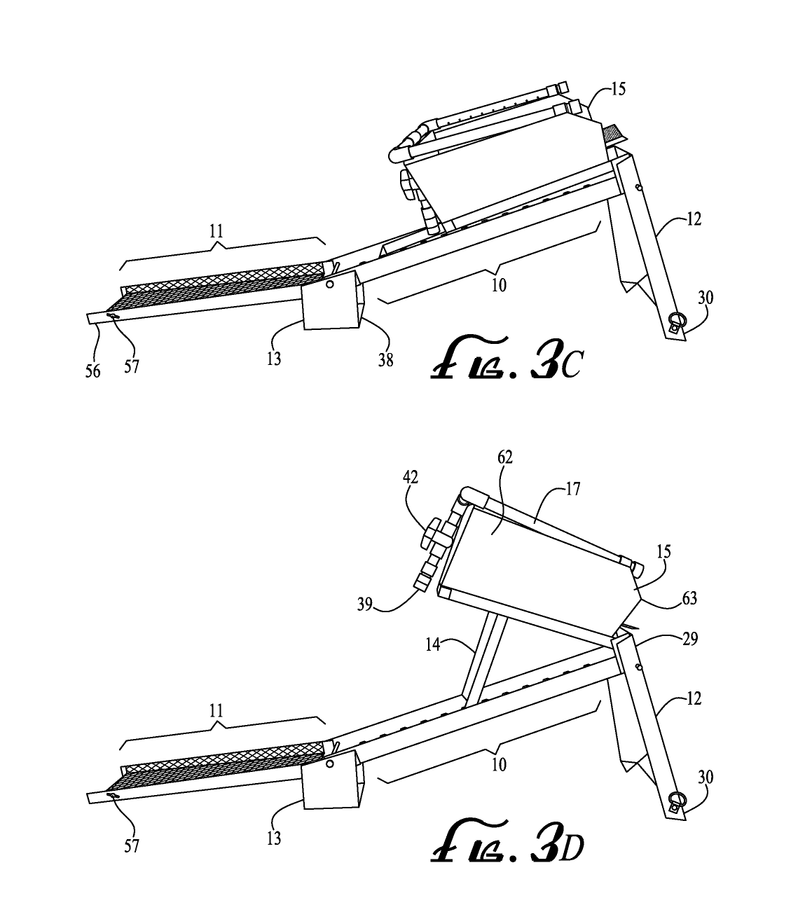

As shown in FIGS. 2 and 3A, with the high banker 8 in its folded position as a backpack 20, in the embodiment described herein the large supporting stand 12 may serve basically as the backpack's frame 12. The shape of the large supporting stand/backpack frame 12, in the embodiment described in this section, may be more narrow at the top end 29, and wider at the bottom end 30, which shape may both assist in allowing the weight of the high banker backpack 20 and the prospecting equipment 25, 26, 27 carried therein/thereon to be distributed over a larger area of a miner's shoulders and back 21 and as shown in FIG. 3B provide a wider base 30 for greater stability of the unfolded apparatus 8. Shoulder straps 28 may fasten to clips 31 located near the top end 29 of the larger supporting stand/backpack frame 12, and also to clips 32 located at the sides near the bottom end 30 of the large supporting stand/backpack frame 12. The underside 33 of the second stage portion of the sluice box 10 may also in one embodiment form a second portion of the backpack frame 33, but may be folded in such a manner that it does not interfere with, or restrict movement of, the miner's legs 34. The smaller or back supporting stand 13 may also be folded away from the underside 33 of the second stage in order to not bump against, restrict, or interfere with the movement of the miner's legs 34. Thus a miner 19 may carry the high banker backpack 20 and other equipment 25, 26, 27, 40—which in one embodiment may have a combined weight of around 25 lbs.—with the miner's hands 35 free to carry other necessary prospecting equipment, such as a pump 36 and a shovel 37.

Once a miner 19 has transported the high banker 8 and prospecting equipment 25, 26, 27, 36, 37 to a prospecting location (such as the location shown in FIG. 7), the miner 19 may remove the high banker backpack 20 from his/her shoulders and back 21 via the shoulder straps 28, as shown in FIG. 3A. The shoulder straps 28 may be unfastened from the clips 31, 32, and each stage of the high banker 9, 10, 11 and supporting stands 12, 13, 14 may be unfolded in preparation for prospecting. The large supporting stand/backpack frame 12 may be unfolded/extended first, as shown in FIG. 3B, with its bottom end 30 facing downward. The back supporting stand 13 may also be unfolded/extended so that the flat surface portion thereof 38 may face downwards, as shown in FIG. 3C. The third stage 11 portion of the sluice box 18 may also be unfolded so that the end portion thereof 56 is fully extended outward, as shown in FIG. 3C. In such a position, the back supporting stand 13 may support both the back end of the second stage 10 portion of the sluice box 18, and a front side of the third stage 11 portion of the sluice box 18, while the larger supporting stand 12 may support the front side/end (or receiving end) of the second stage portion 10 of the sluice box 18. Next, as shown in FIG. 3D, the hopper support stand 14 may be unfolded and positioned so that it props up the receiving end 62 of the hopper 15 above the discharge end 63 (or open side) of the hopper 15 so that the hopper 15 is in an inclined position. The hopper support stand 14 may also be secured to the second stage portion 10 of the sluice box 18, in the manner shown in FIGS. 1, 3D, 6, and 7, so as to minimize the size necessary for a stand 14 to prop up the hopper 15.

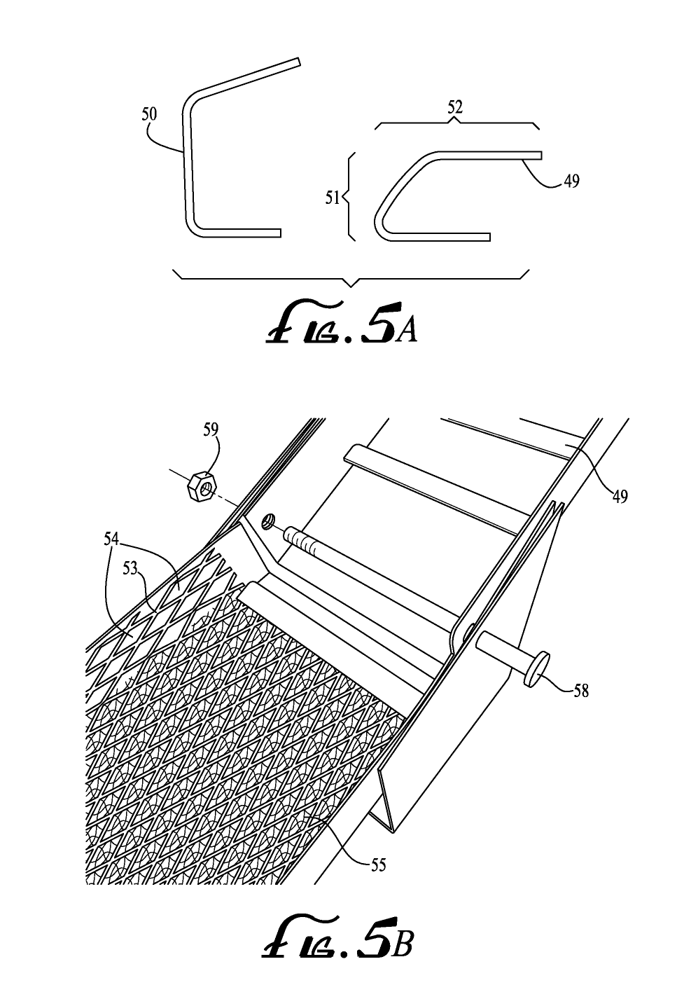

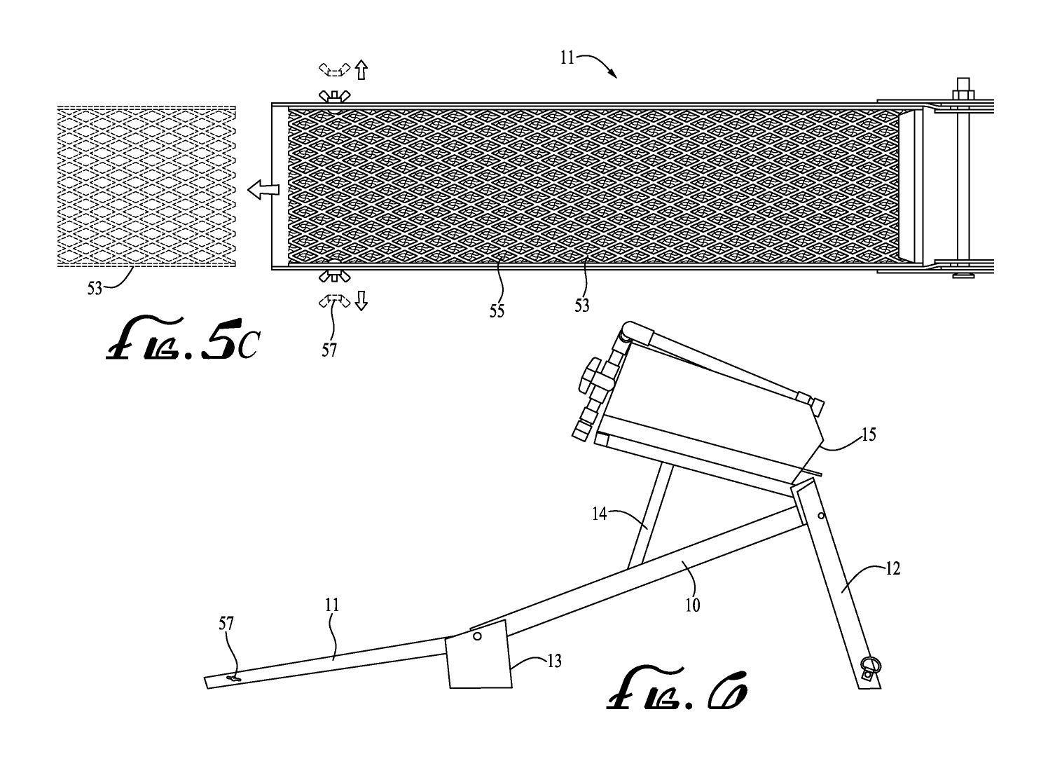

Next, as shown in FIG. 7, one end of the first hose 27 may be connected to a water intake opening 39 of the spray bar 17 (as shown in FIGS. 3D and 5). The opposite end of the first hose 27 may be connected to the pump 36. A second hose 40 may run from the pump 36 to a water source 41. Once the pump 36 and hoses 27, 40 are connected and the pump 36 turned on and a water intake valve 42 in an open (unobstructed) position, water 43 may be pumped through the spray bar 17 (FIG. 7) onto the hopper 15. With water 43 flowing through all stages of the high banker 9, 10, 11, the miner 19 may use a standard-sized shovel 37 to place mineral deposit 44 onto the hopper 15, as shown in FIG. 7 (without having to repeatedly carry the mineral deposit 44 to the water source 41). The entire set up time may take just a few minutes.

The mineral deposit 44 may thus be placed onto the hopper 15 for prospecting purposes, as shown in FIGS. 4 and 7. On the floor of the hopper 15 may be a classifier 16, which may prevent mineral deposit 44 particles greater than a certain size from entering the sluice box 18. The classifier 16 may in one embodiment be an aluminum punch plate perforated with ¼ holes, and may be easily removable from the hopper 15, being in one embodiment attached to the hopper 15 by two bolts and wing nuts 45 (as shown in FIGS. 1, 4, 5, 7).

The spray bar 17 may be perforated with holes 46 through which water 43 may spray onto the classifier 16 and the mineral deposit 44 placed thereon. The mineral deposit 44 that is rejected may fall to the ground 47 around the bottom side 30 of the large supporting stand 12, which might provide additional support to the stand 12. The mineral deposit 44 that is small enough to pass through the classifier 16 may combine with the water 43 to create slurry 48, which may enter the artificial channel of the second stage 10 portion of the sluice box 18 (as shown in FIGS. 5, 7). Due to a smaller spray bar 17 cross section, and second 10 and third stage 11 portions of the sluice box 18 that are substantially narrower than the width W of the hopper 15, a sufficient amount of water 43 flow for effective prospecting may be generated and pass through the holes 46 by a pump 36 that is potentially smaller, lighter, and less energy-consuming.

The second stage portion 10 of the sluice box 18 may be designed to catch the particles of the mineral deposit 44 that are heavier, larger, and/or coarser desirable mineral particles, and also to catch a higher proportion of such particles in comparison to non-desirable particles. Accordingly, as shown in FIGS. 5 and 7, along the bottom of the second stage portion 10 of the sluice box 18 may be riffles 49. As the slurry 48 passes over the second stage riffles 49 along the bottom of the second stage 10 portion of the sluice box 18, some portion of the mineral deposit 44 that are desirable mineral particles are more likely to sink faster, and therefore be trapped behind the riffles 49. As shown in FIG. 5A, a typical second stage riffle 49 may have a shorter height 51 and a top surface portion 52 that is flatter and more horizontally curved against the direction of the slurry 48 flow than a certain typical riffle 50 found in the prior art. In the embodiment described herein, the height 51 of a second stage riffle 49 may be about 1 inch.

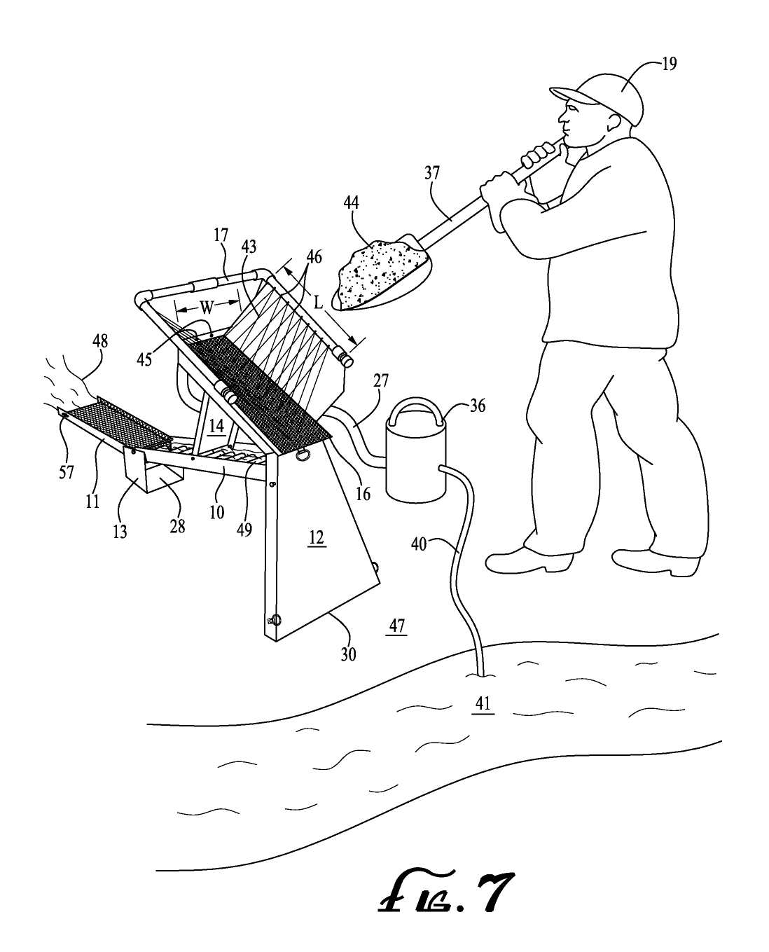

As shown in FIG. 6, the angle of inclination of the second stage 10 portion of the sluice box 18 may be fairly steeply inclined. This angle of inclination may in one embodiment be twenty degrees off of the horizontal axis (more or less), and created by the respective heights of the larger supporting stand 12 and the smaller or back supporting stand 13. A steeper inclination of the second stage 10 may allow the force of gravity to pull down the slurry 48 with increased velocity without requiring that the pump 36 generate more force. In addition, the narrow width of the second stage 10 portion of the sluice box 18 may allow the slurry 48 flow to remain more consistent over the riffles 49, even with less water 43 volume. The length of the second stage 10 portion of the sluice box 18 may be relatively long and, in the embodiment described herein, about 36 inches, providing more opportunity for desirable mineral particles to be trapped in the riffles 49.

The third stage 11 portion of the sluice box 18 may be designed to capture the desirable mineral particles of the mineral deposit 44 that are smaller, lighter, and/or finer. For example, the velocity of the slurry 48 as it passes through to the third stage 11 may be slowed, due to an angle of inclination that is less steep than the second stage 10. This less steep angle of inclination may be created by the back supporting stand 13, which may elevate the front portion of the third stage 11 a certain height above a ground surface 47 (as shown in FIG. 7). The velocity of the slurry 48 may also be slowed by a third stage 11 portion of the sluice box 18 that is wider than the second stage 10 portion. In the embodiment described herein, the width of the third stage 11 portion of the sluice box 18 may be about seven inches.

Along the bottom of the third stage 11 portion of the sluice box 18 may also be features designed to capture particles of mineral deposit 44 that are smaller, lighter, and/or finer desirable mineral particles, which in the embodiment described herein may be a metal sheet 53 containing elongated hexagonal-shaped perforations 54. Underneath the third stage metal sheet 53 may be a matting 55, (as shown in FIGS. 5B, and 5C) for trapping desirable mineral particles of the mineral deposit 44 that are smaller, lighter, and/or finer. The length of the third stage 11 portion of the sluice box 18 may be, in the embodiment described herein (in this Description section), about 30 inches. Once the slurry 48 exits the high banker 8 through the end of the third stage 56, the slurry 48 and remaining mineral deposit 44 therein may be discarded on dry ground 47 away from a potentially fish-bearing water source 41.

Once a miner 19 is finished prospecting at a particular location, and the desirable mineral particles gathered, the three stages 9, 10, 11 of the high banker 8 may be cleaned and folded relatively quickly and conveniently into the configuration for use as a backpack 20. Similar to the unfolding/set up process, this clean-up/gathering/folding process may in one embodiment be completed without the aid of tools, in part by utilizing manually adjustable means such as bolts and wing nuts 45, 57, 58, 59 (as shown in FIGS. 1, 4, 5, 5B, 5C, 7) which in one particular embodiment may be of a ¼″ size. For example, after the pump 36 is turned off and the hose 27 removed from the water intake opening 39, two particular bolts and wing nuts 43 may be removed in order to detach the classifier 16 from the hopper 15 of the first stage 9 for cleaning. In the same manner, the classifier 16 may be detached during prospecting to extract small stones or pebbles that may become lodged in the classifier's 16 perforations.

To begin cleaning the second stage 10 (FIGS. 5, 6), desirable mineral particles may first be gathered from behind the second stage riffles 49 (for example, by using a snuffer bottle to suction up the concentrated minerals). The steeper angle of inclination of the second stage 10, and possibly in combination with the unique design of the riffles 49, may potentially result in a higher concentration of desirable mineral particles trapped behind the riffles 49, which may allow less steps to separate the desirable mineral particles from the undesirable mineral particles. In one embodiment, the incorporation of nonremovable riffles 37 along the bottom of the second stage 10 portion of the sluice box 18 may eliminate an otherwise-required cleaning step of removing the riffles 50 from the sluice box 18. Such nonremovable riffles 49 may also allow for a more seamless second stage 10 design of the sluice box 18 with less cracks and areas where sand and other undesirable mineral particles would otherwise become lodged—the absence of which may speed up the cleaning process. Second stage riffles 49 that are not removed when the high banker 8 is in the configuration as a backpack 20 may also provide greater structural strength to the second portion of the backpack frame 33 (as shown in FIGS. 3A and 3B), in the embodiments where the underside of the second stage 33 is used in such a manner, and/or to the second stage 10 generally.

To begin cleaning the third stage 11, the metal sheet 53 and the matting 55 may be removed, as shown in FIG. 5C. Desirable mineral particles caught in the matting 55 may be extracted by for example, shaking and/or rinsing, and then placed into the bucket 25 for safekeeping and transportation purposes. Next, as one possible step of cleaning, the bucket 25 may be placed at the end of the third stage 56, and the pump 36 may be turned on at a reduced level of force (with the first and second hoses 27, 40 connected), thereby rinsing the desirable mineral particles left in the second and third stage 10, 11 portions of the sluice box 18 into the bucket 25. Alternatively, a step of cleaning may include detaching the second stage 10 portion of the sluice box 18 from the third stage 11 portion, by removing a bolt 58 and nut 59 connecting the two stages 10, 11 as shown in FIGS. 4B and 5C. The bucket 25 may then be placed at the bottom end of the second stage 10 portion of the sluice box 18, and the desirable mineral particles may be rinsed into the bucket 25, and then the desirable mineral particles in the third stage 11 portion may also be rinsed into the bucket 25 separately. Excess water 43 may then be removed from the bucket 25, which bucket 25 may contain gathered desirable mineral particles.

Once cleaned, the matting 55 and expanded metal sheet of riffles 53 may be re-inserted into the third stage 11 portion of the sluice box 18, and the high banker 8 and the stages thereof 9, 10, 11, along with supporting stands 12, 13, 14, may be folded back up into a backpack configuration 20. The bucket 25 and other equipment such as hoses 27, 40 may be placed in the hopper/backpack compartment 15, resting upon and/or being securely placed above the compartment floor/closed side 22 of the hopper 15 (opposite from the open ended side 60), and with the two hopper sidewalls 23, 24 and classifier 16 surface functioning as three sidewalls 16, 23, 24 of the hopper backpack compartment 15, with the prospecting equipment (e.g., bucket 25, pan 26, hoses 27, 40) being secured in the hopper compartment 15 by straps 61. It is anticipated that the entire clean up and folding up process, once the miner 19 is familiar with the high banker 8 could take about or less than thirty minutes.

I claim:

1. A placer mining apparatus configured for portability as a backpack, the apparatus comprising:
a first stage comprising a hopper formed with surrounding hopper sides and a hopper screen floor defining a hopper volume which is adapted when elevated at an inclined angle to receive mined material deposited into the hopper volume and pass desired material smaller than a selected screen size through the hopper screen floor while discharging waste material through an open discharge end of the hopper volume,
at least a second stage formed as an elongated sluice box having one end thereof hinged to the discharge end of the hopper volume of said first stage for receiving material passed through the hopper screen floor and further extracting desired material particles therefrom, and
a supporting stand having one end hinged to the one end of the sluice box of said second stage for elevating it at an inclined angle when the supporting stand is pivoted to an elevated support position for placer mining use,
wherein said second stage and said supporting stand hinged at the respective one ends thereof are adapted to fold together and lie flat under a backside of the hopper screen floor of said first stage for storage, and said supporting stand doubles as a backpack frame while the hopper volume of said first stage doubles as an external storage compartment when the placer mining apparatus is folded as a backpack for portability.

2. The apparatus of claim 1, wherein the apparatus folds and is carried as a backpack so that the supporting stand is placed against a person's back and shoulders, and wherein shoulder straps are attached to the supporting stand as carrying straps for the backpack.

3. The apparatus of claim 1, wherein the hopper has a length and a width so that the hopper area defined by the hopper length and the hopper width is large enough for the head of a standard-sized shovel to fit within the hopper area, the hopper thereby configured for the standard-sized shovel to place material thereon.

4. The apparatus of claim 3, wherein the apparatus folds and is carried as a backpack so that the hopper width and the surrounding sides of the hopper forming an external storage compartment for the backpack are configured for securely placing a standard-sized bucket substantially within the external storage compartment.

5. The apparatus of claim 1, wherein one of the surrounding sides forming the external storage compartment, when the apparatus is in its folded position and carried as a backpack, comprises an external storage compartment bottom side for securely placing an object above the external storage compartment bottom side.

6. The apparatus of claim 1, further comprising a third stage that is a second portion of a sluice box, wherein the width of the second stage is narrower than the width of the third stage, and the widths of both the second stage and the third stage are narrower than the hopper width.

7. The apparatus of claim 6, wherein the angle of inclination of the second stage is substantially steeper than the third stage.

8. A three-stage placer mining apparatus, said apparatus comprising:
a first stage including a hopper for material deposited thereon and moved in a slurry with a water flow, having a classifier floor for passing material in the slurry of a selected particle size therethrough;
an inclined second stage receiving material in the slurry passed by the classifier floor of the first stage and including a box forming an artificial channel with fixed riffles along a bottom of the second stage box; and
an inclined third stage, the third stage communicating with an outflow of the second stage and including a box forming an artificial channel with matting along the bottom of the third stage box; wherein the second stage box is arranged at a substantially steeper angle of inclination than the angle of inclination of the third stage box, and the width of the second stage box is less than the width of the third stage box, so that the slurry passes through the second stage box at a greater velocity than through the third stage box; whereby, the second stage captures more heavier desirable mineral particles than the third stage.

9. The apparatus of claim 8, wherein the second stage riffles have a short height and are sharply curved in the direction against the flow of the slurry.

10. The apparatus of claim 8, further comprising a front larger supporting stand positioned to elevate a front end of the second stage box, and a back smaller supporting stand positioned to elevate a back end of the second stage box as well as a front end of the third stage box, and wherein the front larger supporting stand and the back smaller supporting stand determine the respective angles of inclination of the second stage box and the third stage box.

11. The apparatus of claim 10, wherein the vertical positions of the front end of the second stage box with respect to the front larger supporting stand, and the back end of the second stage box with respect to back smaller support stand are adjustable, and the vertical position of the front end of the third stage box with respect to the back smaller supporting stand is also adjustable, so that the angles of inclination of the second stage box and the third stage box are thereby adjustable.

12. The apparatus of claim 11, wherein the front larger supporting stand holds an open discharge end of the hopper in an elevated position, and the apparatus further comprises a hopper supporting stand that holds a receiving end of the hopper in an elevated position above the open discharge end so that the hopper is sloped downwardly toward the open discharge end thereof, and towards the first end of the second stage box.

13. The apparatus of claim 12, where the three stages, the front larger supporting stand, the back smaller supporting stand, and the hopper supporting stand, are configured to be folded into a compact storage position.

14. The apparatus of claim 14, wherein the stages fold together compactly so that, when the apparatus is in its folded position, the apparatus is adapted to be worn as a backpack so that the hopper is positioned about the same elevation as a person's back and shoulders, and the hopper is adapted for use as an external storage compartment of the backpack, with one side of the hopper comprising a floor surface of the external storage compartment.

15. A portable three-stage high banker apparatus that, when in a folded position, is also a backpack, said apparatus comprising:
a first stage formed as a hopper comprising a classifier floor and surrounding walls with an open end on a discharge side thereof for allowing deposited material rejected from passing through the classifier floor to exit the hopper when supported in an inclined position for use and fall to the ground as discharged material, the hopper having a length and a width configured to be sufficient for accommodating a standard sized shovel depositing material into the hopper while being configured to form an outer storage compartment when in its folded position;
a foldable second stage for positioning substantially below the classifier floor of the hopper of said first stage and communicating into a foldable third stage, which second and third stages together comprise a sluice box for material passed by the classifier floor of the hopper of said first stage;
wherein, the three stages are configured to fold together into the backpack in its folded position; whereby, the high banker backpack is conveniently portable to carry to a placer mining destination.

16. The apparatus of claim 15, wherein the width of the second stage is narrower than the third stage and both are narrower than the width of the first stage hopper.

17. The apparatus of claim 16, wherein the angle of inclination of the second stage is substantially steeper than the angle of inclination of the third stage.

18. The apparatus of claim 17, wherein the first stage further comprises a spray bar for providing a decreased water output passing through the classifier floor of the first stage, and the width of the second stage and the angle of inclination of the second stage are configured for a consistent speed of water flow to match the decreased water output.

19. The apparatus of claim 21, wherein the diameter of the spray bar is less than one inch.

20. The apparatus of claim 15, further comprising a supporting stand for supporting said apparatus when unfolded for use, which supporting stand, when the high banker backpack is in its folded position, forms a backpack frame for the high banker backpack to which shoulder straps are fastened for carrying the backpack.
